(19) United States
(12) Patent Application Publication
(10) Pub. No.: US 2015/0298359 A1
(43) Pub. Date: Oct. 22, 2015

(54) COMPOUNDING A POLYMER WITH A PREHEATED PELLET MASTERBATCH

(71) Applicant: INEOS EUROPE AG, Vaud (CH)

(72) Inventor: Gary Lindsay Pitman, Stirling (GB)

(21) Appl. No.: 14/646,080

(22) PCT Filed: Nov. 22, 2013
(86) PCT No.: PCT/EP2013/074487

§ 371 Date: May 20, 2015

(30) Foreign Application Priority Data
Nov. 28, 2012 (EP) 12194652.9

(51) Int. Cl. B29B 13/02; C08K 3/04

(52) U.S. Cl. CPC B29B 13/02; C08K 3/04; B29K 2023/06; B29K 2023/12

(57) ABSTRACT

The present invention relates to a process for compounding, and in particular to a process for compounding a polymer with a pellet masterbatch, which process comprises passing the polymer and the pellet masterbatch to a compounding extruder, the temperature of the polymer being T° C., characterised in that the pellet masterbatch is heated using a heating fluid to a temperature of T-10° C. or higher prior to being passed to the extruder.

The present invention relates to a process for compounding, and in particular to a process for compounding a polymer with a pellet masterbatch.

Pellet masterbatches are widely used in the compounding of polymer to introduce desired additives to the polymer. Typical additives include colorants (pigments), antioxidants, lubricants, flame retardants and numerous other additives which give the compounded material a desired property. A pellet masterbatch comprises a concentrated additive, or additive mixture, mixed with a carrier, and is generally used because it is easier to handle and also easier to control when dosing to the compounding step than the raw additive materials, which may often be liquids or fine powders.

Examples of processes using masterbatches for polyethylene polymers can be found in, for example WO 2012/058200, U.S. Pat. No. 4,369,267 and WO 99/57193.

The pellet masterbatch may be mixed with the polymer to be compounded in an extruder, or pre-mixed with the polymer prior to the extruder. In the extruder the polymer and the masterbatch are heated, melted and mixed. Shear is applied to ensure homogenous mixing.

It is has now been found that the compounding process can be improved by pre-heating the masterbatch prior to the extruder.

Thus, in a first aspect the present invention provides a process for compounding a polymer with a pellet masterbatch, which process comprises passing the polymer and the pellet masterbatch to a compounding extruder, the temperature of the polymer being T° C., characterised in that the pellet masterbatch is heated using a heating fluid to a temperature of T-10° C. or higher prior to being passed to the extruder.

In particular, the first aspect of the present invention provides a process for compounding a polymer with a pellet masterbatch, which process comprises passing the polymer and the pellet masterbatch to a compounding extruder, the temperature of the polymer being T° C. and wherein the pellet masterbatch is stored at a temperature of T-20° C. or lower, characterised in that the pellet masterbatch is heated using a heating fluid to a temperature of T-10° C. or higher prior to being passed to the extruder.

The term “pellet masterbatch” refers to a masterbatch of one or more additives on a carrier which is in the form of a pellet. The carrier is usually a polymeric resin, and most usually is selected based on the polymer to be compounded. For example, a polyethylene carrier is used for the masterbatch when the polymer to be compounded is a polyethylene. (For ease of reference, “masterbatch” may be used herein and means “pellet masterbatch” even if the “pellet” is not recited.)

It has been found that providing heat to a pellet masterbatch to increase the temperature of the masterbatch compared to the polymer to be compounded (“virgin polymer”) makes the subsequent melting easier, and reduces the specific energy needed to be applied in the extruder to achieve the mixing and allows higher extruder throughputs to be achieved.

The term “heating fluid” refers to a gas or liquid which is used to provide heat to heat the pellet masterbatch. Examples of suitable fluids include gases, such as air, and liquids, such as water.

In one embodiment, the process of the first aspect of the present invention may be achieved by “direct heating” of the masterbatch. As used herein “direct heating” refers to a process where physical contact occurs between the masterbatch and a heating fluid which provides the heat to heat the masterbatch.

Thus, a heating fluid, such as heated air, nitrogen or superheated steam, is passed through the masterbatch to heat it. This may be done to the masterbatch prior to mixing with the polymer, or the masterbatch may be mixed with at least some, and preferably all, of the polymer, and heat applied to the mixture. It can be noted that when the masterbatch is mixed with at least some of the polymer prior to the compounding extruder, the heat present in the polymer can increase the temperature of the masterbatch, but although this can result in redistribution of the heat energy this cannot reduce the subsequent heat required in the extruder.

When using direct heating, direct heating of the masterbatch prior to mixing with the polymer is preferred.

In this embodiment it is preferred that the heating fluid is a gas at the temperature to which the pellet masterbatch is heated by the heating fluid (at the pressure at which the pellet masterbatch is heated, which could be above or below atmospheric pressure but is preferably atmospheric pressure). This avoids the need to subsequently vaporise the heating fluid to remove it from the pellet masterbatch. For this reason gases such as steam are generally not preferred, at least at atmospheric pressure. Gases such as nitrogen or dry air are most preferred in this embodiment.

In general in the present invention, but especially when using “direct” heating, it is preferred that, on entering the extruder, the pellet masterbatch or the mixture of pellet masterbatch and polymer where mixing has taken place prior to the extruder, contains less than 500 ppm water, preferably less than 250 ppm water.

Most preferably, the heating of the masterbatch in the first aspect of the present invention is achieved by “indirect heating” of the masterbatch.

Further, in a second aspect, the present invention provides a process for compounding a polymer with a pellet masterbatch, which process comprises passing the polymer, which has a temperature T° C., and the pellet masterbatch to a compounding extruder, characterised in that the pellet masterbatch is heated by indirect heat exchange prior to being passed to the extruder.

In this second aspect the masterbatch is preferably initially at a lower temperature than the polymer to be compounded (virgin polymer).

Preferably, in this second aspect the temperature of the polymer prior to compounding is T° C., the pellet masterbatch is stored at a temperature of T-20° C. or lower, and the pellet masterbatch is heated prior to being passed to the extruder to a temperature of T-10° C. or higher i.e. as preferred in the first aspect. In general, and as an example, a temperature differential between the virgin polymer and the masterbatch can exist where the virgin polymer retains heat from earlier processing steps. A pellet masterbatch, by contrast, is usually stored for use in a suitable feed vessel or silo at ambient temperature.

In the present invention the polymer temperature is T° C. As used herein this temperature is measured immediately prior to mixing with the masterbatch or, when polymer is not mixed with the masterbatch prior to the extruder, immediately prior to the polymer being fed to the extruder.

Preferably, the masterbatch is stored at a temperature 30° C. or more below the temperature of the polymer (T-30° C. or lower), such as 40° C. or more below (T-40° C. or lower).

The invention (first and second aspects) is particularly useful when the masterbatch is stored at a temperature of less than 30° C., especially less than 20° C., for example in the range −40° C. to 30° C. or −40° C. to 20° C.

The polymer temperature (T° C.) may typically be at least 30° C., such as at least 40° C.

The polymer may typically be at a temperature (T° C.) of from 20° C. to 70° C., such as 30° C. to 70° C., or even 40° C. to 70° C.

“Indirect heat exchange” as used herein means a process where heat is transferred from one material (the heating fluid in this case) to another (the masterbatch in this case) without the two materials themselves being in physical contact. The heat transfer usually takes place through a physical barrier, such as a plate or wall, which keeps the materials physically separate but allows heat transfer between them. Metals, such as stainless steel, are suitable for this. The heat is provided using the heating fluid, such as air or water, which circulates on its side of the heat exchanger, with heat being transferred through the barrier to the material on the other side.

Heat exchangers suitable for facilitating indirect heat exchange between solids, such as the pellet masterbatch, and a heating fluid, such as air or water, are well-known. Suitable heat exchangers for the present invention are bulk solids heat exchangers, such as the CoperionWaeschle BULK-X-CHANGE® or Solex bulk heat exchanger.

In the process of the present invention, and using either direct or indirect heating, it is possible to mix the polymer and the masterbatch prior to the extruder, and heat the mixture. (In this embodiment the masterbatch may be mixed with all or only a portion of the polymer which is passed to the extruder.) In such scenarios it is generally desired that the mixture is heated to a temperature of from 30° C. to 70° C. and passed to the extruder, although higher temperatures can be used.

It is most preferred, however, that the masterbatch is heated prior to mixing with the polymer, especially when using indirect heating. In particular, the volume of the masterbatch is significantly smaller than the volume of virgin polymer and hence, for indirect heating, a much smaller heat exchanger is required, and a smaller flow of heating fluid. When separately heated the masterbatch may typically be heated to at a temperature of from 30° C. to 70° C., although higher temperatures can be used.

It is also worth noting that, once a masterbatch heating system according to the present invention is installed, it is possible to use the system to preheat polymer prior to the compounding extruder even when masterbatch is not being added to the polymer.

There, is no particular upper limit on the temperature to which the masterbatch should be heated, except that it should not be heated so high that it melts prior to the mixing. For avoidance of doubt, the masterbatch may be heated to above the temperature T° C. (either separately or after mixing with the polymer, in which latter case the polymer itself is also heated). (It should be noted that the virgin polymer may also be separately heated prior to mixing/extrusion, although when it is already at temperatures above ambient the advantages of doing so diminish.)

In particularly advantageous embodiments of the first and second aspects of the present invention, the heating is achieved by using water from a downstream pelletising step. In particular, after compounding the compounded polymer (comprising the polymer and the masterbatch additives) may be pelletised in a pelletising system.

In one example, if the die plate of the pelletising system is steam heated, the condensed steam (hereinafter “condensate water”) may be used as a source of heat for the masterbatch.

As an alternative, and in a preferred embodiment, if the pelletising system uses water to cool and/or transport the pellets after extrusion, this water may be used. Examples of such systems include underwater pelletising systems and water ring pelletizing systems. In an underwater pelletising system the compounded polymer is pelletised underwater i.e. the die face is underwater, into a water stream which not only cools the pellets but also carries them away from the extruder to subsequent processing (including dewatering and drying) In a water ring system, the die face is not underwater, but water is again provided to transport and cool the pellets. Preferably, the pelletising system is an underwater pelletising system.

In general, the water in such systems is subsequently separated from the cooled pellets, cooled in a pellet water cooler, and then recycled for re-use. This water is hereinafter referred to as “pellet water”. For avoidance of doubt this term is intended merely to indicate the source rather than the presence of pellets therein.

Similarly, for ease of reference, the water from the downstream pelletising step is hereinafter generally referred to as “pelletising system water” to indicate that it derives from the downstream pelletising step but without indicating its specific source. Thus, “pellet water” and “condensate water” described above are two specific examples of “pelletising system water”.

The heat in the pelletising system water may be used to provide heating to the masterbatch in a number of different ways.

For example, and in a preferred embodiment, the pelletising system water can itself be used as the heating medium in a heat exchanger for heating of the masterbatch by indirect heating. Suitable heat exchangers are bulk solids heat exchangers, such as already described.

Alternatively the pelletising system water may be heat exchanged with an intermediate fluid, such as air or water, which is then used to heat the masterbatch. For example, if the pelletising system water quality is not suitable for use in a bulk solids heat exchanger, for example due to contaminants therein, it could be first heat exchanged to heat an intermediate water stream, and this heated intermediate water stream passed to a bulk solids heat exchanger for indirect heating of the masterbatch.

As a yet further alternative, the pelletising system water may be heat exchanged to heat an intermediate air stream, and this heated intermediate air stream used for either direct or indirect heating of the masterbatch.

In general the stream of pelletising system water is taken and used as a source of heat to heat the masterbatch. The pelletising system water, after use (heat exchange with the masterbatch or with an intermediate fluid if one is used) is then returned to the pelletising system. At the same time the use in heat exchange cools the pelletising system water, which has the further advantage that it reduces the duty required to cool the pelletising system water.

In a most preferred embodiment the pelletising system water used is pellet water. The pellet water is usually at a temperature of 50-80° C. before cooling, and thus is ideally suited to heating the masterbatch to the required temperatures.

In this embodiment, the pelletising system generally comprises a circulation pump for the pellet water circulation, and preferably the stream of pellet water for use heating the masterbatch is taken from a location upstream of the pellet water cooler, but downstream of the pellet water circulation pump. After use it is preferably returned upstream of the circulation pump. This enables the use of the pressure difference between the upstream and downstream of the pump to obtain the required flow of pellet water for the masterbatch heating.

The proportion of the pellet water required to heat the masterbatch depends on both the initial temperature of the masterbatch and the required final temperature, but in general terms the proportion of the total pellet water flow is less than 10%, usually less than 4%, and preferably less than 2%.

One advantage of the relatively low proportion of the overall pellet water flow which is required for masterbatch heating is that the present invention can relatively easily be applied to existing systems using existing pellet water circuits with minimal disruption to the normal pellet water system.

Whilst the direct effect both on the overall duty required to cool the pelletising system water and also on the thermal energy required to heat the masterbatch in the extruder (compared to when it is not pre-heated according to the present invention) is relatively small compared with the energy required to melt the polymer, the effect of the present invention can significantly reduce the residence time of the polymer/masterbatch mixture in the extruder required for good mixing, allowing a higher throughout rate to be used, which in turn has a significant effect on the specific energy applied by the extruder.

Without wishing to be bound by theory, the specific energy applied in the extruder arises from application of shear to the polymer/masterbatch mixture, and whilst the heating requirement in the extruder is only reduced by a relatively small amount according to the process of the present invention, the reduced residence time of the polymer/masterbatch mixture means that significantly less shear is applied.

In particular, it has been found that the process of the present invention can give in excess of a 5% increase in extruder throughput, and correspondingly an extruder specific energy reduction, compared to a process without the masterbatch heating.

Thus, in another embodiment the present invention provides a process for compounding a polymer with a pellet masterbatch, which process comprises passing the polymer and the pellet masterbatch to a compounding extruder, characterised in that the pellet masterbatch is heated by indirect heat exchange prior to being passed to the extruder and at least one of the following apply:
i) the extruder is operated with a specific energy input at least 1% less than the equivalent process without heating of the pellet masterbatch prior to the extruder,
ii) the extruder is operated at a polymer throughput at least 2% higher than the equivalent process without heating of the pellet masterbatch prior to the extruder.
   Preferably, at least one of the following applies:
i) the extruder is operated with a specific energy input at least 3% less than the equivalent process without heating of the pellet masterbatch prior to the extruder,
ii) the extruder is operated at a polymer throughput at least 5% higher than the equivalent process without heating of the pellet masterbatch prior to the extruder.

More generally, the present invention may be applied to any process for compounding a polymer with a pellet masterbatch.

The polymer may be in pellet form prior to the compounding extruder of the present invention, or may be in powder form prior to the compounding extruder. The present invention can be particularly advantageously applied when the polymer passed to the extruder is a polymer powder and retains heat from the upstream processing steps from which has been obtained. Examples of such processing steps include the polymerisation reaction itself, but more directly any degassing steps by which polymer powder is separated from unreacted reactants and other reaction components, which steps often involve heating of the polymer powder.

The polymer may be any suitable polymer, but is preferably a polyolefin, more preferably is a polypropylene or a polyethylene, and most preferably a polyethylene. Examples of processes involving polyethylenes, can be found, for example, in WO 2012/059200, U.S. Pat. No. 4,369,267 and WO 99/57193 as already noted

Where the polymer is a polyethylene is may be a high density polyethylene (HDPE), a medium density polyethylene (MDPE), a low density polyethylene (LPDE) or a linear low density polyethylene (LLDPE). Polyethylenes may also be sold commercially based on suitability for particular product applications. Thus, polyethylenes may be referred to as “pipe grade”, “film grade”, “wire and cable grade”, “blow moulding grade” and the like, and the present invention may be applied to all such grades as required.

The present invention is particularly preferably applied to pipe grade polyethylenes. A number of standards are known for pipe grade polyethylenes, but in general “pipe grade” polyethylenes as used herein are those which can be classified for pipes according to ASTM D3350-12“Standard Specification for Polyethylene Plastics Pipe and Fittings Materials”.

Nevertheless, other classifications for pipes are also known, often depending on the intended use. ISO 4437:2007, for example, specifies the general properties of the polyethylene (PE) compounds for the manufacture of pipes, the physical and mechanical properties of the pipes made from these compounds and the requirements for the marking of such pipes, when intended to be used for the supply of gaseous fuels. Similarly, ISO 4427-1:2007 specifies the general aspects of polyethylene (PE) piping systems (mains and service pipes) intended for the conveyance of water for human consumption.

Further, based on the polymer strength, pressure pipes can be classified in different categories according to ISO 9080 and ISO 12162, examples being PE63, PE80 or PE100. The number here (e.g. 63, 80, 100) indicates the minimum required strength (MRS) in MPa times 10. Thus, 100 means an MRS of 10 MPa, and the higher the number, the higher the design pressure that can be applied.

Generally one or more additives may be present in a total amount of 20 to 70% by weight of the pellet masterbatch.

The masterbatch is usually added to the virgin polymer in an amount corresponding to between 1 and 15 wt % of the combined weight of virgin polymer and masterbatch, preferably between 2 and 10 wt %, and more preferably between 4 and 10 wt %, with a range of 5 to 8 wt % most preferred.

The masterbatch preferably comprises one or more colorants, and most preferably comprises carbon black. Other additives may also be present, and examples of those which are often used with carbon black include flow agents, such as fluoropolymers, catalyst neutralisers, such as calcium stearate, and anti-oxidants, such as phenolic anti-oxidants. Where the masterbatch comprises carbon black this is preferably present in the masterbatch in an amount of from 25 to 55 wt % based on the total weight of the masterbatch.

The use of a carbon black masterbatch results in a black compounded polymer. The polyethylene polymers which may be produced in the present invention preferably have at least 2% carbon black, and most preferably are those designated PEXXXXXXC under ASTM 3350-12 where each X is a number representing a property of the polymer according to the definitions in ASTM3350-12 and the “C” designates the presence of carbon black in amounts as defined in ASTM 3350-12. (For example the first number represents the density and the second the melt index.)

As already noted, the carrier component of the masterbatch is generally selected based on the polymer to be compounded. Thus, as with the polymer to be compounded, the carrier component is preferably a polyolefin, more preferably is a polypropylene or a polyethylene, and most preferably a polyethylene. Suitable polyethylenes include high density polyethylenes (HDPE), medium density polyethylenes (MDPE), low density polyethylenes (LPDE) and linear low density polyethylenes (LLDPE). A wide number of such components are used in the art, and may equally be used in the process of the present invention.

### EXAMPLES

### 1: Examples of Pellet Water Requirements

The following examples illustrate the use of pellet water from a downstream underwater pelletising system to heat the masterbatch prior to passing the masterbatch to the extruder with the polymer to be compounded. In each case the temperature of the polymer to be compounded (T° C.) is 70° C., and the masterbatch is pre-heated to 60° C. (T-10° C.).

In the underwater pelletising system, pellet water is used to cool the compounded polymer in an amount of 0.012 m³/kg of polymer compounded. A portion of this is taken and used to heat the masterbatch to the required temperature. In these examples there is a reduction in pellet water temperature during the heat exchange with the masterbatch of 10° C.

Two different carbon black masterbatches are considered, one having 40 wt % of carbon black, and the other 30 wt % of carbon black. In all examples the masterbatch is added to the polymer in an amount so as to give a carbon black content in the compounded polymer of 2.2 wt % (and hence different amounts are required depending on the starting masterbatch).

For each masterbatch, examples are given where the masterbatch is initially at a temperature of either 50° C. or −40° C., which represent limits of likely temperatures for the masterbatch prior to heating. (50° C. represents T-20° C.)

Finally, examples are given for extruder throughputs of 10,000 kg/h and 60,000 kg/h, these being typical rates for commercial compounding processes.
Results with Masterbatch Initially at 50° C.

Table 1 represents the results where the masterbatch is initially at 50° C., and thus a 10° C. increase in temperature is required in the pre-heating.

TABLE 1

| Extruder throughput | kg/h | 10,000 | 60,000 | 10,000 | 60,000 |
|---|---|---|---|---|---|
| Carbon black in | wt % | 40 | 40 | 30 | 30 |
| masterbatch | | | | | |
| Masterbatch | wt % | 5.50 | 5.50 | 7.33 | 7.33 |
| addition rate to | | | | | |
| polymer | | | | | |
| Power to heat | kW | 2.5 | 15.0 | 3.6 | 21.9 |
| masterbatch by | | | | | |
| 10° C. | | | | | |
| Water flow rate to | m³/hr | 0.22 | 1.31 | 0.32 | 1.91 |
| heat masterbatch | | | | | |
| Total water flow in | m³/hr | 120 | 720 | 120 | 720 |
| pelletising system | | | | | |
| Proportion of total | % | 0.18 | 0.18 | 0.27 | 0.27 |
| water flow used for | | | | | |
| heating masterbatch | | | | | |

Results with Masterbatch Initially at −40° C.

Table 2 represents the results where the masterbatch is initially at −40° C., and thus a 100° C. increase in temperature is required.

TABLE 2

| Extruder throughput | kg/h | 10,000 | 60,000 | 10,000 | 60,000 |
|---|---|---|---|---|---|
| Carbon black in | wt % | 40 | 40 | 30 | 30 |
| masterbatch | | | | | |
| Masterbatch | wt % | 5.50 | 5.50 | 7.33 | 7.33 |
| addition rate to | | | | | |
| polymer | | | | | |
| Power to heat | kW | 25.0 | 149.8 | 36.4 | 218.5 |
| masterbatch by | | | | | |
| 100° C. | | | | | |
| Water flow rate to | m³/hr | 2.19 | 13.12 | 3.19 | 19.14 |
| heat masterbatch | | | | | |
| Total water flow in | m³/hr | 120 | 720 | 120 | 720 |
| pelletising system | | | | | |
| Proportion of total | % | 1.82 | 1.82 | 2.66 | 2.66 |
| water flow used for | | | | | |
| heating masterbatch | | | | | |

It can be seen that even when a 100° C. temperature rise in the masterbatch is required, the proportion of the total water flow in the pelletising system which is required for the pre-heating is still only a few percent. This shows not only that the pelletising water system easily includes sufficient heat to enable the required heating of the masterbatch, but that only a relatively small proportion of the flow is required, so the process has minimal disruption to the normal pellet water system.

Although the above examples use a 10° C. reduction in the pellet water temperature during heating of the masterbatch it will be apparent that a different reduction in temperature could be operated and the flows would then be amended accordingly. For example by having a reduced contact time (e.g. using a smaller heat exchanger) a smaller reduction in pellet water temperature could be obtained, so a higher flow would be used. Nevertheless, it is clear that the proportion of the total water flow required for heating the masterbatch is generally going to be relatively low.

An advantage of this is that the present invention can relatively easily be applied to existing systems using existing pellet water circuits.

### 2: Examples of Throughput Increase Obtainable

The following examples illustrate the beneficial effect on extruder throughput of heating the masterbatch prior to passing the masterbatch to the extruder with the polymer to be compounded.

As with the examples above, in each case the temperature of the polymer to be compounded (T° C.) is 70° C. In these examples a single carbon black masterbatch is considered, having 40 wt % of carbon black. As in the examples above, the masterbatch is added to the polymer in an amount so as to give a carbon black content in the compounded polymer of 2.2 wt %.

In a comparative example, the masterbatch is initially at a temperature of −40° C., and no heating is applied to this prior to the extruder. The extruder throughput is 50,000 kg/hr, and the extruder operates with a specific energy of 0.2 kWh/kg. (It is worth noting that the relative benefits noted below would be the same for extruders of different sizes.)

Based on the temperature of the masterbatch prior to the extruder (and the specific energy of the extruder) a residence time in the extruder of 7.5 seconds can be determined as necessary for the melting of the masterbatch.

To demonstrate the improvement in throughput obtainable by pre-heating the masterbatch, the calculation is repeated but with a masterbatch which has been heated at 60° C. prior to the extruder.

In this case, the residence time necessary for the melting the masterbatch is reduced to 6.4 seconds.

(It should be noted that this residence time depends on the masterbatch temperature entering the extruder, but would be the same regardless of whether the masterbatch was initially (prior to pre-heating to 60° C.) at −40° C. or a higher temperature. It is also worth noting that although the absolute residence times determined depend on certain parameters used, such as masterbatch heat capacity, the relative change is still representative.)

Due to the reduced residence time to melt the masterbatch, the overall residence time required in the extruder (which includes also polymer melting and a melt residence time) is reduced, as is the specific energy which is applied to the polymer and masterbatch.

Whilst the above example is based on an extruder throughput of 50,000 kg/hr, the reduced requirement for melting the masterbatch alternatively allows an increase in extruder throughput from 50,000 kg/hr to approximately 53,100 kg/hr whilst maintaining an equivalent mixture quality.

1-15. (canceled)

16. A process for compounding a polymer with a pellet masterbatch, which process comprises passing the polymer and the pellet masterbatch to a compounding extruder, the temperature of the polymer being T° C., characterised in that the pellet masterbatch is heated using a heating fluid to a temperature of T-10° C. or higher prior to being passed to the extruder.

17. A process according to claim 16 wherein the pellet masterbatch is heated by direct heating by passing the heating fluid through the masterbatch to heat it.

18. A process according to claim 16 wherein the pellet masterbatch is stored at a temperature of T-20° C. or lower.

19. A process for compounding a polymer with a pellet masterbatch, which process comprises passing the polymer, which has a temperature T° C., and the pellet masterbatch to a compounding extruder, and characterised in that the pellet masterbatch is heated by indirect heat exchange prior to being passed to the extruder.

20. A process according to claim 19 wherein the pellet masterbatch is stored at a temperature of T-20° C. or lower, and the pellet masterbatch is heated prior to being passed to the extruder to a temperature of T-10° C. or higher.

21. A process according to claim 19 wherein the masterbatch is heated using the heating fluid prior to mixing with the polymer.

22. A process according to claim 19 wherein the masterbatch is mixed with at least some, and preferably all, of the polymer, and the mixture is heated using the heating fluid prior to being passed to the extruder.

23. A process as claimed in claim 19 wherein the masterbatch is stored at a temperature 30° C. or more below the temperature of the polymer (T-30° C. or lower), such as 40° C. or more below (T-40° C. or lower).

24. A process as claimed in claim 19 wherein T° C. is at least 30° C., and preferably at least 40° C.

25. A process as claimed in claim 19 wherein the heating is achieved by using water from a downstream pelletising step using a pelletising system.

26. A process as claimed in claim 25 wherein the die plate of the pelletising system is steam heated and the condensed steam (“condensate water”) is used as a source of heat for the masterbatch.

27. A process as claimed in claim 25 wherein the pelletising system uses water to cool and/or transport the pellets after extrusion, and this water (“pellet water”) is used as a source of heat for the masterbatch.

28. A process according to claim 19 wherein the pellet masterbatch is added to the polymer in an amount corresponding to between 1 and 10 wt % of the combined weight of polymer and pellet masterbatch.

29. A process according to claim 19 wherein the polymer passed to the extruder is a polymer powder.

30. A process according to claim 16 wherein the polymer is a polypropylene or a polyethylene, and especially a polyethylene.

31. A process according to claim 16 wherein the masterbatch is heated using the heating fluid prior to mixing with the polymer.

32. A process according to claim 16 wherein the masterbatch is mixed with at least some, and preferably all, of the polymer, and the mixture is heated using the heating fluid prior to being passed to the extruder.

33. A process as claimed in claim 16 wherein the masterbatch is stored at a temperature 30° C. or more below the temperature of the polymer (T-30° C. or lower), such as 40° C. or more below (T-40° C. or lower).

34. A process as claimed in claim 16 wherein T° C. is at least 30° C., and preferably at least 40° C.

35. A process according to claim 16 wherein the pellet masterbatch is added to the polymer in an amount corresponding to between 1 and 10 wt % of the combined weight of polymer and pellet masterbatch.

36. A process according to claim 16 wherein the polymer passed to the extruder is a polymer powder.

37. A process according to claim 16 wherein the polymer is a polypropylene or a polyethylene, and especially a polyethylene.
